(19) United States
(12) Patent Application Publication
(10) Pub. No.: US 2010/0266829 A1
(43) Pub. Date: Oct. 21, 2010

(54) AROMATIC POLYIMIDE FILM AND METHOD FOR PRODUCING THE SAME

(75) Inventors: Hideki Iwai, Yamaguchi (JP); Takao Miyamoto, Yamaguchi (JP); Toshiyuki Nishino, Yamaguchi (JP); Yasuhiro Nagoshi, Yamaguchi (JP)

Correspondence Address: NIXON PEABODY, LLP, 401 9TH STREET, NW, SUITE 900, WASHINGTON, DC, 20004-2128, US

(73) Assignee: UBE INDUSTRIES, LTD., Ube-shi, Yamaguchi (JP)

(21) Appl. No.: 12/743,031

(22) PCT Filed: Nov. 14, 2008
(86) PCT No.: PCT/JP2008/070802

§ 371 Date: May 14, 2010

(30) Foreign Application Priority Data
Nov. 16, 2007 (JP) 2007-298678

(51) Int. Cl. B32B 5/00; B32B 27/00; B29C 71/02

(52) U.S. Cl. 428/220; 264/236

(57) ABSTRACT

An aromatic polyimide film having a thickness in the range of 5-250 μm and comprising biphenyltetracarboxylic acid units comprising 3,3′,4,4′-biphenyltetracarboxylic acid units and 2,3,3′,4′-biphenyltetracarboxylic acid units in a molar ratio of 75:25 to 97:3 and p-phenylenediamine units in a molar ratio of 100:102 to 100:98 has thermal resistance and physical characteristics equivalent to those of the known aromatic polyimide film comprising 3,3′,4,4′-biphenyltetracarboxylic acid units and p-phenylenediamine units and showing good thermal resistance and physical characteristics and is favorably produced in industry.

### FIELD OF THE INVENTION

The present invention relates to a novel aromatic polyimide film and a process for producing the same.

### BACKGROUND OF THE INVENTION

An aromatic polyimide film produced by the steps of preparing a polyamic acid from a 3,3′,4,4′-biphenyltetracarboxylic acid, its acid anhydride, or its ester (referred to, hereinafter, as 3,3′,4,4′-biphenyltetracarboxylic acid component or s-BPDA component) and p-phenyl-enediamine (referred to, hereinafter, as PPD) in an essentially equivalent molar ratio and heating the polyamic acid to high temperatures shows good heat resistance, high dimensional stability, and good mechanical strength. Therefore, the aromatic polyimide film has been widely utilized for manufacturing various industrial materials, particularly, substrates for electronic devices.

Japanese Patent Provisional Publication (JPA) 11-209,488 discloses a method for improving surface characteristics of an aromatic polyimide film produced from the s-BPDA component and PPD by applying plasma discharge treatment to the polyimide film. This publication contains a description to the effect that the s-BPDA component can be used with other aromatic tetracarboxylic acid components such as 2,3,3′,4′-biphenyltetracarboxylic acid component and pyromellitic acid component, provided the amount of the other aromatic tetracarboxylic acid components do not exceed 90 mol. %. However, the publication never teaches any effects given by the co-employment of the other aromatic tetracarboxylic acid components.

As is described above, the aromatic polyimide film produced from s-BPDA component and PPD is a polymer film showing various favorable characteristics such as good heat resistance, high dimensional stability and good mechanical strength. However, the aromatic polyimide film has poor surface activity, as is described in the above-mentioned publication. Therefore, it is not easy to manufacture a laminated structure comprising the aromatic polyimide film and other materials arranged on the film, unless the surface of the aromatic polyimide film is modified.

Further, there is caused a problem in the course of preparation of an aromatic polyimide film from s-BPDA component and PPD. The problem resides in that a polyamic acid produced by the reaction of s-BPDA component and PPD in a polar solvent shows high viscosity. For this reason, it is practically difficult to employ a solution containing the s-BPDA component and PPD in high concentrations. This means that productivity of the aromatic polyimide film is not high and that it is not easy to obtain an aromatic polyimide film having a large thickness.

It is known that the process for preparing an aromatic polyimide film from s-BPDA component and PPD in industry comprises the steps of spreading a polyamic acid on a surface of a support such as a running belt or a rotating drum to form a polyamic acid film, heating the polyamic acid film by bringing the film into contact with a gas heated to temperatures of 50 to 180° C., whereby evaporating a portion of the solvent to give a solid film having a solvent content of 30 to 50 wt. %, and separating the solid film from the support. The solid film of poly-amic acid separated from the support is generally heated to temperatures of 400 to 500° C. to convert the solid film into a polyimide film under the bound conditions. It is important for obtaining an aromatic polyimide film of high quality that the solid film is smoothly separated from the support with less force. Therefore, it is very important in the industrial procedure for carrying out the above-mentioned process for the preparation of an aromatic polyimide film that a period of time from the spreading of the polyamic acid solution to the smooth separation of the solid film is shortened.

In addition, there is a further problem in that the aromatic polyimide film prepared from s-BPDA and PPD (i.e., an aromatic polyimide film comprising s-BPDA units and PPD units) has a low water vapor transmission. The low water vapor transmission is not always wrong. However, an aromatic polyimide film of this type is apt to swell when it is employed as a substrate for manufacturing electronic devices and subjected to a soldering process at high temperatures. This is because water contained in the polyimide film is vaporized in the soldering procedure, resulting in partial swelling of the resulting polyimide film.

### SUMMARY OF THE INVENTION

The present inventors have made studies for the purpose of obtaining a new aromatic polyimide film that is free from the known problems observed in the production of an aromatic polyimide film from s-BPDA and PPD and the poor water vapor transmission. The inventors, however, have bone in their minds ought to have good heat resistance, high dimensional stability and good mechanical strength equivalent or superior to those shown by the conventional aromatic polyimide film produced from the combination of s-BPDA and PPD.

As a result of the studies, the inventors have found that a new aromatic polyimide film produced from PPD and a biphenyltetracarboxylic acid component comprising s-BPDA component and a specific small amount of 2,3,3′,4′-biphenyltetracarboxylic acid component (referred to, hereinafter, as a-BPDA component) shows heat resistance, dimensional stability and mechanical strength as high as those of the conventional aromatic polyimide film produced from the combination of s-BPDA and PPD, but the period required for producing the new aromatic polyimide film can be shortened. Moreover, the new aromatic polyimide film shows a relatively high water vapor transmission.

Accordingly, the present invention resides in an aromatic polyimide film having a thickness in the range of 5 to 250 μm and comprising biphenyltetracarboxylic acid units comprising 3,3′,4,4′-biphenyltetracarboxylic acid units and 2,3,3′,4′-biphenyltetracarboxylic acid units in a molar ratio of 75:25 to 97:3 and a p-phenylenediamine units in a molar ratio of 100:102 to 100:98.

The aromatic polyimide film of the invention can be easily produced by a process comprising the steps of:

preparing a solution containing a biphenyltetracarboxylic acid component comprising a 3,3′,4,4′-biphenyltetracarboxylic acid component and a 2,3,3′,4′-biphenyl-tetracarboxylic acid component in a molar ratio of 75:25 to 97:3 and p-phenylenediamine in a molar ratio of 100:102 to 100:98 in a polar organic solvent in a concentration of 15 to 25 wt. %;

stirring the solution at temperatures in the range of 10 to 80° C., whereby obtaining a polyamic acid solution;

spreading the polyamic acid solution on a support selected from the group consisting of a running belt or a rotating drum, whereby forming a solution film;

bringing the solution film into contact with a gas heated to temperatures in the range of 50 to 180° C., whereby evaporating a portion of the solvent from the solution film, resulting in preparation of a solid film having a solvent content in the range of 30 to 50 wt. %;

separating the solid film from the support; and

heating the separated solid film to temperatures in the range of 400 to 550° C.

### EFFECTS OF THE INVENTION

The aromatic polyimide film of the invention has good heat resistance, high dimensional stability and good mechanical strength equivalent to those of the conventional aromatic polyimide film produced from s-BPDA component and PPD but the industrial procedure performing the its production can be shortened. Further, an aromatic polyimide film having a thickness of 140 μm or more can be easily produced. It has been known that it is difficult in the industrially applicable procedure to produce an aromatic polyimide film comprising s-BPDA units and PPD units and having such large thickness. Furthermore, since the new aromatic polyimide film shows a relatively high water vapor transmission as compared with the water vapor transmission shown by the conventional aromatic polyimide film produced from s-BPDA component and PPD, the new aromatic polyimide film is particularly favorably employable as a substrate for manufacturing electronic device which is necessarily subjected in its manufacture to a heating process at high temperatures.

### PREFERRED EMBODIMENTS OF THE INVENTION

Preferred embodiments of the aromatic polyimide film are described below.

(1) The molar ratio of 3,3′,4,4′-biphenyltetracarboxylic acid units and 2,3,3′,4′-biphenyltetracarboxylic acid units is in the range of 80:20 to 96:4, more preferably in the range of 85:15 to 95:5.

(2) The aromatic polyimide film has a water vapor transmission in the range of 0.1 to 0.5 g·mm/m²·24 Hr, more preferably in the range of 0.1 to 0.4 g·mm/m²·24 Hr, most preferably in the range of 0.1 to 0.3 g·mm/m²·24 Hr.

(3) The thickness of the aromatic polyimide film is in the range of 25 to 230 μm.

The process for producing an aromatic polyimide film of the invention from PPD and a biphenyltetracarboxylic acid component comprising a combination of s-BPDA component and a specific small amount of a-BPDA component can be carried out by essentially the same procedure as the known process for producing an aromatic polyimide film from PPD and s-BPDA component.

Therefore, the aromatic polyimide film of the invention can be produced by the process comprising the steps of:

preparing a solution containing a biphenyltetracarboxylic acid component comprising a 3,3′,4,4′-biphenyl-tetracarboxylic acid component and a 2,3,3′,4′-biphenyl-tetracarboxylic acid component in a molar ratio of 75:25 to 97:3 and p-phenylenediamine in a molar ratio of 100:102 to 100:98 in a polar organic solvent in a concentration of 15 to 25 wt. % (preferably 17 to 24 wt. %, more preferably 19 to 23 wt. %, most preferably 20 to 22 wt. %);

stirring the solution at temperatures in the range of 10 to 80° C., whereby obtaining a polyamic acid solution;

spreading the polyamic acid solution on a support selected from the group consisting of a running belt or a rotating drum, whereby forming a solution film;

bringing the solution film into contact with a gas heated to temperatures in the range of 50 to 180° C., whereby evaporating a portion of the solvent from the solution film, resulting in preparation of a solid film having a solvent content in the range of 30 to 50 wt. %;

separating the solid film from the support; and

heating the separated solid film to temperatures in the range of 400 to 550° C. (preferably 420 to 530° C., more preferably 450 to 510° C.)

The steps required for the process for the production of the aromatic polyimide film are hereinbelow described in more detail.

The process for producing the aromatic polyimide film of the invention starts from the preparation of a solution comprising a biphenyltetracarboxylic acid component and p-phenylenediamine component in the same manner as that of the conventional process.

The biphenyltetracarboxylic acid component employed for the production of the aromatic polyimide film of the invention comprises 3,3′,4,4′-biphenyltetracarboxylic acid component (s-BPDA component) and 2,3,3′,4′-biphenyl-tetracarboxylic acid component (a-BPDA component) in a molar ratio of 75:25 to 97:3 (s-BPDA:a-BPDA). The 3,3′,4,4′-biphenyltetracarboxylic acid component can be a free acid, its acid anhydride, or its ester. However, the acid anhydride is preferred from the viewpoint of industrial procedure. The 2,3,3′, 4′-biphenyltetracarboxylic acid component also can be a free acid, its acid anhydride, or its ester. However, the acid anhydride is also preferred from the viewpoint of industrial procedure. It should be noted that other tetracarboxylic acid components such as a pyromellitic acid component and a benzophenonetetracarboxylic acid component can be employed with the combination of s-BPDA and a-BPDA, provided that the amount of those other tetracarboxylic acid components is less than 10 molar % per the total amount of the combination of s-BPDA and a-BPDA.

The diamine component to be employed for preparing the polyamic acid by the reaction with the biphenyltetracarboxylic acid component is p-phenylenediamine (PPD). It should be noted that a small amount (10 molar % or less per the amount of PPD) of other diamine components (e.g., 4,4′-diaminodiphenyl ether and 3,4′-diaminodiphenyl ether) can be co-employed.

The reaction of the biphenyltetracarboxylic acid component with the diamine component can be performed in a polar organic solvent. Examples of the employable polar organic solvents include amide solvents such as N,N-dimethylsulfoxide, N,N-dimethylformamide, N,N-diethylformamide, N,N-dimethylacetamide, N,N-diethyl-acetamide, N-methyl-2-pyrrolidone and hexamethylenephosphoramide, phenolic solvents such as cresol and phenol, heterocyclic compound solvents such as pyridine, and tetramethylurea.

The solution of a biphenyltetracarboxylic acid component and diamine in a polar organic solvent for the preparation of a polyamic acid may contain a fine filer which is effective for improving surface characteristics of the resulting aromatic polyimide film. Further, an imidation catalyst may be contained for accelerating the imidation reaction. Furthermore, an organic phosphorus compound may be contained for assisting easy separation of the resulting solid film form the support. The filler, imidation catalyst and organic phosphorus compound can be placed in the solution before, during or after the production of a polyamic acid.

Examples of the imidation catalysts include substituted or unsubstituted nitrogen-containing heterocyclic compounds, N-oxide products of the substituted or unsubstituted nitrogen-containing compound, substituted or unsubstituted amino acid compounds, and aromatic hydro-carbon compounds or aromatic heterocyclic compounds having a hydroxyl group. Preferred are lower alkyl imidazoles such as 1,2-dimethylimidazole, N-methylimidazole, N-benzyl-2-methylimidazole, 2-methylimidazole, 2-ethyl-4-imidazole and 5-methylbenzimidazole; benzimidazoles such as N-benzyl-2-methylimidazole; and substituted pyridines such as isoquinoline, 3,5-dimethylpyridine, 3,4-dimethyl-pyridine, 2,5-dimethylpyridine, 2,4-dimethylpyridine, and 4-n-propylpyridine. The imidation catalyst can be employed preferably in an amount of 0.01 to 2 equivalents (more preferably 0.02 to 1 equivalent) per one equivalent of an amide acid unit of the polyamic acid.

Examples of the fillers include fine inorganic oxide powders such as titanium dioxide power, silicon dioxide (silica) powder, magnesium oxide powder, aluminum oxide (alumina) powder and zinc oxide powder; fine inorganic nitride powder such as silicon nitride powder and titanium nitride powder; fine inorganic carbide powder such as silicon carbide powder; and fine inorganic salt powders such as calcium carboxylate powder, calcium sulfate powder, and barium sulfate powder. These fillers can be employed in combination, The filler can be dispersed in the solution by a known procedure.

Examples of the organic phosphorus compounds include phosphates such as monocaproyl phosphate, monooctyl phosphate, monolauryl phosphate, monomyristyl phosphate, monocetyl phosphate, monostearyl phosphate, monophosphate of triethyleneglycol monodecyl ether, monophosphate of tetraethyleneglycol monolauryl ether, monophosphate of diethyleneglycol monostearyl ether, dicaproyl phosphate, dioctyl phosphate, dicapryl phosphate, dilauryl phosphate, dimyristyl phosphate, dicetyl phosphate, distearyl phosphate, diphosphate of tetraethyleneglycol mononeopentyl ether, diphosphate of triethyleneglycol monotridecyl ether, diphosphate of tetraethyleneglycol monolauryl ether, and diphosphate of diethyleneglycol monostearyl ether; and amine salts these phosphates. Examples of the amines include ammonia, monomethylamine, monoethylamine, monopropylamine, monobutylamine, dimethylamine, diethylamine, dipropylamine, dibutylamine, trimethylamine, triethylamine, tripropylamine, tributyl-amine, monoethanolamine, diethanolamine and triethanolamine.

The reaction in the polar organic solvent solution for producing the polyamic acid from the biphenyltetracarboxylic acid component and diamine can be performed by stirring the solution at a temperature in the range of 10 to 80° C. The biphenyltetracarboxylic acid component and diamine are generally contained in the solution in a total amount of 15 to 25 wt. %, preferably 17 to 24 wt. %, more preferably 19 to 23 wt. %, most preferably 20 to 22 wt. %.

The solid film of a polyamic acid solution can be prepared by spreading a dope solution (i.e., the solution comprising the polyamic acid, optionally, an imidation catalyst, an organic phosphorus compound and a filler, in an organic solvent) on a support to give a solution layer and then heating the solution layer at 100 to 180° C., preferably 100 to 170° C., for 5 to 60 minutes, to give a self-supporting film which is separable from the support prior to the ordinary curing step. The polyamic acid solution preferably has a polymer (polyamic acid) concentration in the range of approx. 5 to 25 wt. %. The support can be a stainless substrate or a stainless belt. Specifically, if the solid film is prepared continuously, the dope solution is extruded through a T die to spread down on a surface of a running endless stainless belt. The resulting solution layer formed on the support is brought into contact with a gas heated at 50 to 180° C. (preferably air heated at 90 to 160° C.) to evaporate a portion (approx. 60 wt. %) of the solvent, whereby producing the solid film having a solvent content in the range of approx. 30 to 50 wt. %. The thickness of the solution layer as well as the thickness of the solid film can be determined in consideration of the desired aromatic polyimide film.

The resulting solid film is subsequently separated from the support. It is preferred to separate the solid film from the support with no force, but the separation can be carried out at a force less than 70 N/m.

The polyimide film is produced by heating the solid film.

The step for heating the solid film to give the polyimide film can be performed under such conditions that the imidation becomes almost complete. The heating step is performed generally at the highest temperature in the range of 400 to 500° C., preferably 450 to 530° C., most preferably 450 to 510° C.

For example, the heating step can be favorably carried out at an initial temperature in the range of approx. 100 to 400° C., for approx. 0.1 to 5 hours, preferably for approx. 0.2 to 3 hours, so as to slowly advance evaporation of the solvent and imidation. It is more preferred that the heating step is carried out in the following three stages: a first stage at a relatively low temperature of approx. 100 to 170° C. for approx. 1 to 30 minutes, a second stage at a temperature of 170 to 220° C. for approx. 1 to 30 minutes, and a third stage at a high temperature of 220 to 400° C. for approx. 1 to 30 minutes. A fourth stage for heating the film to a high temperature of 400 to 550° C. can be additionally carried out, if required. When the solid film is heated to a temperature of 250° C. or higher in the continuous production, both sides of the solid film are preferably bound at least in a traverse direction of the continuous film using a tenter such as pin tenters, clips or a frame.

If a polyimide film having a large thickness, such as a thickness in the range of 140 to 250 μm, specifically 160 to 240 μm or 70 to 230 μm, should be produced, the polyamic acid solution preferably has a polymer concentration in the range of approx. 19 to 25 wt. %, more preferably approx. 20 to 23 wt. %, most preferably approx. 21 to 23 wt. %.

### EXAMPLES

### Preparation of Dope Solution

(1) Preparation of Dope Solution 1 (a-BPDA/s-BPDA=10/90)

A biphenyltetracarboxylic acid component comprising 3,3′,4,4′-biphenyltetracarboxylic dianhydride (90 mol. %) and 2,3,3′,4′-biphenyltetracarboxylic acid dianhydride (10 mol. %) and p-phenylenediamine in an equivalent amount were dissolved in N,N-dimethylacetamide, and the resulting solution was stirred at 40-50° C. for 30 hours to cause a polymerization reaction, yielding a polyamic acid solution having a solution viscosity of 2,000 poises (determined at 30° C. by a Brookfield viscometer) and a polyamic acid concentration of 22 wt. %. To the polyamic acid solution were added 0.1 weight part of triethanolamine salt of monostearyl phosphate and 0.5 weight part of colloidal silica (mean particle size: 800 angstroms), per 100 weight parts of the polyamic acid, to prepare Dope solution 1.

(2) Preparation of Dope Solution 2 (a-BPDA/s-BPDA=5/95)

A biphenyltetracarboxylic acid component comprising 3,3′,4,4′-biphenyltetracarboxylic dianhydride (95 mol. %) and 2,3,3′,4′-biphenyltetracarboxylic acid dianhydride (5 mol. %) and p-phenylenediamine in an equivalent amount were dissolved in N,N-dimethylacetamide, and the resulting solution was stirred at 40-50° C. for 30 hours to cause a polymerization reaction, yielding a polyamic acid solution having a solution viscosity of 3,080 poises (determined at 30° C. by a Brookfield viscometer) and a polyamic acid concentration of 22 wt. %. To the polyamic acid solution were added 0.1 weight part of triethanolamine salt of monostearyl phosphate and 0.5 weight part of colloidal silica (mean particle size: 800 angstroms), per 100 weight parts of the polyamic acid, to prepare Dope solution 2.

(3) Preparation of Dope Solution 3 (a-BPDA/s-BPDA=30/70)

A biphenyltetracarboxylic acid component comprising 3,3′,4,4′-biphenyltetracarboxylic dianhydride (70 mol. %) and 2,3,3′,4′-biphenyltetracarboxylic acid dianhydride (30 mol. %) and p-phenylenediamine in an equivalent amount were dissolved in N,N-dimethylacetamide, and the resulting solution was stirred at 40-50° C. for 30 hours to cause a polymerization reaction, yielding a polyamic acid solution having a solution viscosity of 1,900 poises (determined at 30° C. by a Brookfield viscometer) and a polyamic acid concentration of 22 wt. %. To the polyamic acid solution were added 0.1 weight part of triethanolamine salt of monostearyl phosphate and 0.5 weight part of colloidal silica (mean particle size: 800 angstroms), per 100 weight parts of the polyamic acid, to prepare Dope solution 3.

(4) Preparation of Dope Solution 4 (s-BPDA)

3,3′,4,4′-biphenyltetracarboxylic dianhydride and p-phenylenediamine in an equivalent amount were dissolved in N,N-dimethylacetamide, and the resulting solution was stirred at 40-50° C. for 30 hours to cause a polymerization reaction, yielding a polyamic acid solution having a solution viscosity of 2,000 poises (determined at 30° C. by a Brookfield viscometer) and a polyamic acid concentration of 18 wt. %. To the polyamic acid solution were added 0.1 weight part of triethanolamine salt of monostearyl phosphate and 0.5 weight part of colloidal silica (mean particle size: 800 angstroms), per 100 weight parts of the polyamic acid, to prepare Dope solution 4.

### [Production and Evaluation of Solid Film and Production of Aromatic Polyimide Film]

There was set an apparatus for preparing a solid film comprising a metallic endless belt supported by multiple rotatable rollers, a T-die having an inlet for a dope solution and a slit, a solid film-separating unit arranged apart from the T-die at a predetermined space. The dope solution was introduced into the T-die and extruded continuously through the slit onto a surface of the metallic endless belt while it was running, whereby the dope solution spread on the surface of the belt to prepare a dope solution film. The dope solution film was brought into contact with air heated to approx. 120-150° C. Subsequently, the resulting solid film was separated by means of the solid film-separating unit.

The separated solid film was bound at both sides and heated up to a maximum temperature of 500° C., to give the desired aromatic polyimide film.

The above-mentioned procedure for the preparation of a solid film was repeated using each one of the aforementioned Dope solution 1, Dope solution 2, Dope solution 3, and Dope solution 4. The flow rate of the dope solution extruded from the slit was adjusted to finally give a polyimide film having the predetermined thickness. The solid film was separated from the endless belt running at a different rate. The easiness of the separation was determined and evaluated by the below-described method. The solvent content of the solid film was determined by the below-described method.

### (a) Determination/Evaluation of Easiness of Separation

A force (N/m: m is a width of the solid film) required for separating the solid film from the belt was determined by means of a handy automatic spring balance. The evaluation was made in the following manner: Easiness A: no force was required; Easiness B: a force of from 10 N/m to 30 N/m (not inclusive) was required; Easiness C: a force of from 30 N/m to 70 N/m (not inclusive) was required; and Unacceptable: a force of 70 N/m or more was required.

(b) Determination of the Solvent Content The separated solid film was cut to give a square sample (200 mm×200 mm). The weight (W1) of the square sample was determined. The square sample was than heated at 400° C. for 30 minutes to give a dry sample, and the weight (W2) of the dry sample was determined. The solvent content of the solid film was calculated using the following formula:

Solvent content(wt. %)=[(W1−W2)/W1]×100

### [Evaluation of Aromatic Polyimide Film]

The obtained aromatic polyimide film was subjected to determination of its tensile strength, its elongation, and its end tear resistance.

### (a) Tensile Strength and Elongation

The tensile strength and elongation were determined by means of a tensile strength tester according to JIS K7161 at a rate of pulling of 50 mm/min. (cross-head speed). Five specimen (width 10 mm, length 200 mm) were tested and the value is expressed in terms of an average value.

### (b) End Tear Resistance

The end tear resistance was determined according to JIS C2151 B method.

### Examples, Comparison Example, Reference Examples

### (1) Aromatic Polyimide Film (Thickness: 75 μm)

TABLE 1

| | Ref. Ex. | | Example | | | |
|---|---|---|---|---|---|---|
| | 1 | 2 | 1 | 2 | 3 | Com. Ex. 1 |
| Dope solution | 4 | 4 | 1 | 1 | 1 | 3 |
| Rate of film | 1 | 1.10 | 1.27 | 1.33 | 1.40 | 0.90 |
| production | | | | | | |
| Solvent content (%) | 39.0 | 39.5 | 40.3 | 41.5 | 42.6 | — |
| Easiness of | C | Fail | B | B | C | A |
| separation | | | | | | |
| Tensile | 1 | 1.03 | 1.15 | 1.12 | 1.17 | — |
| strength | | | | | | |
| Elongation | 1 | 0.93 | 1.38 | 1.62 | 1.76 | — |
| End tear | 1 | 0.85 | 0.93 | 0.87 | 0.86 | — |
| resistance | | | | | | |

Remarks:
Rate of film production: relative value
Tensile strength: relative value
Elongation: relative value
End tear resistance: relative value
In Comparison Example 1, Dope solution was spread at a relatively low rate because the resulting solid film was apt to be fragile if the rate of film production was increased.

As is apparent from the results shown in Table 1, there was no problem in increase of the rate of film production by approx. 30% when the dope solution prepared from a combination of s-BPDA and the specific amount of a-BPDA was used. In addition, the resulting aromatic polyimide film showed physical characteristics essentially equivalent to those of an aromatic polyimide film prepared using s-BPDA alone as the biphenyltetracarboxylic acid component.

### [Evaluation of Water Vapor Transmission]

Each of the aromatic polyimide films produced in Reference Example 1 and Example 1 was determined in its coefficient of water vapor transmission (g·mm/m²·24 Hr), according to JIS K7129B method. The determined values are set forth in Table 2.

TABLE 2

| | Coefficient of water vapor transmission |
|---|---|
| Reference Ex. 1 | 0.079 |
| Example 1 | 0.188 |

### (2) Aromatic Polyimide Film (Thickness: 180 μm)

TABLE 3

| | Reference Ex. 3 | Example 4 |
|---|---|---|
| Dope solution | 4 | 2 |
| Rate of film | 1 | 1.00 |
| production | | |
| Solvent content(%) | (blowing) | — |
| Easiness of | C | A |
| separation | | |

Remarks:
Rate of film production: relative value

Tensile strength, elongation and end tear resistance of the aromatic polyimide film produced in Example 4 were 1.33, 1.07 and 2.36, respectively, which are relative values to 1 of the respective values of the aromatic polyimide film produced in Reference Ex. 1.

As is apparent from the results shown in Table 3 and the below-given Table 4, there was no problem of blowing, in the case that the dope solution prepared from a combination of s-BPDA and the specific amount of a-BPDA was used, while the blowing was observed when an aromatic polyimide film having a large thickness was produced a dope solution prepared from s-BPDA alone.

### (3) Aromatic Polyimide Films (Thickness: 220 μm and 200 μm)

TABLE 4

| | Example 5 | Example 6 |
|---|---|---|
| Dope solution | 2 | 2 |
| Easiness of separation | A | A |
| Tensile strength | 1.25 | 1.28 |
| Elongation | 0.96 | 1.19 |
| End tear strength | 2.85 | 3.11 |

Remarks:
Tensile strength: relative value
Elongation: relative value
End tear resistance: relative value

What is claimed is:

1. An aromatic polyimide film having a thickness in the range of 5 to 250 μm and comprising biphenyltetracarboxylic acid units comprising 3,3′,4,4′-biphenyltetracarboxylic acid units and 2,3,3′,4′-biphenyltetracarboxylic acid units in a molar ratio of 75:25 to 97:3 and a p-phenylenediamine units in a molar ratio of 100:102 to 100:98.

2. The aromatic polyimide film of claim 1, in which the molar ratio of 3,3′,4,4′-biphenyltetracarboxylic acid units and 2,3,3′,4′-biphenyltetracarboxylic acid units is in the range of 80:20 to 96:4.

3. The aromatic polyimide film of claim 2, in which the molar ratio of 3,3′,4,4′-biphenyltetracarboxylic acid units and 2,3,3′,4′-biphenyltetracarboxylic acid units is in the range of 85:15 to 95:5.

4. The aromatic polyimide film of claim 1, which has a water vapor transmission in the range of 0.1 to 0.5 g·mm/m²·24 Hr.

5. The aromatic polyimide film of claim 1, in which the thickness is in the range of 25 to 230 μm.

6. A process for producing a polyimide film of claim 1, which comprises the steps of:
preparing a solution containing a biphenyltetracarboxylic acid component comprising a 3,3′,4,4′-biphenyltetracarboxylic acid component and a 2,3,3′,4′-biphenyltetracarboxylic acid component in a molar ratio of 75:25 to 97:3 and p-phenylenediamine in a molar ratio of 100:102 to 100:98 in a polar organic solvent in a concentration of 15 to 25 wt. %;
stirring the solution at temperatures in the range of 10 to 80° C., whereby obtaining a polyamic acid solution;
spreading the polyamic acid solution on a support selected from the group consisting of a running belt or a rotating drum, whereby forming a solution film;
bringing the solution film into contact with a gas heated to temperatures in the range of 50 to 180° C., whereby evaporating a portion of the solvent from the solution film, resulting in preparation of a solid film having a solvent content in the range of 30 to 50 wt. %;
separating the solid film from the support; and
heating the separated solid film to temperatures in the range of 400 to 550° C.
